(19) United States
(12) Patent Application Publication
(10) Pub. No.: US 2012/0070709 A1
(43) Pub. Date: Mar. 22, 2012

(54) LITHIUM SECONDARY BATTERY

(76) Inventors: Satoshi Goto, Aichi (JP); Kaoru Inoue, Osaka (JP)

(21) Appl. No.: 13/322,959

(22) PCT Filed: Jun. 5, 2009
(86) PCT No.: PCT/JP2009/060385

§ 371 Date: Nov. 29, 2011

(51) Int. Cl. H01M 4/02; H01M 4/13; H01M 10/36

(52) U.S. Cl. 429/94; 429/209; 429/223

(57) ABSTRACT

The lithium secondary battery obtained by the present invention is a lithium secondary battery provided with a nonaqueous electrolyte and electrode body 80 having a positive electrode and a negative electrode, wherein a positive electrode 10 has a structure having a positive electrode active material layer 14 which contains a positive electrode active material 16, and which is supported on a positive electrode collector 12, the total pore volume within the positive electrode active material layer 14 is within a range of 0.13 cm³/g to 0.15 cm³/g, and 75% or more of the total pore volume is formed of pores 18 with a diameter of 0.3 μm or less.

### TECHNICAL FIELD

The present invention relates to a lithium secondary battery, and relates particularly to a lithium secondary battery with improved durability for high-rate discharge.

### BACKGROUND ART

In recent years, lithium-ion batteries, nickel hydrogen batteries and other secondary batteries are becoming increasingly important as vehicle-mounted power sources or power sources for personal computers and handheld devices. Lithium-ion batteries in particular provide high energy densities with low weight, making them attractive as vehicle-mounted high-output power sources. In a typical configuration, this type of lithium-ion battery is charged and discharged by means of the movement of lithium ions between the positive and negative electrodes. Patent Document 1 is an example of prior art in the field of lithium ion batteries.

### PRIOR ART

### Patent Document

Patent Document 1: Japanese Patent Application Laid-open No. 2005-158623

### DISCLOSURE OF THE INVENTION

However, it is anticipated that lithium-ion batteries will be used in applications involving repeated high-rate discharge (rapid discharge). A typical example of a lithium-ion battery that might be used in this way is one used as a power source in a vehicle (such as a lithium-ion battery installed in a hybrid vehicle, which combines a lithium ion battery as a power source with an internal combustion engine or other power source based on a different operating principal). However, although ordinary, conventional lithium-ion batteries exhibit relatively high durability with respect to low-rate charge-discharge cycles, they are liable to performance loss (increased internal resistance and the like) from charge-discharge patterns involving repeated high-rate discharge.

Patent Document 1 describes a technology aimed at achieving high battery output by giving the positive electrode active material layer a porosity of at least 25% but no more than 35%, thereby optimizing the amount of nonaqueous electrolyte solution permeating the positive electrode active material layer. However, although this technology may achieve high battery output, it has not been able to improve durability with respect to charge-discharge patterns involving repeated high-rate discharge (for example, rapid discharge at the level required by lithium-ion batteries used as vehicle-mounted power sources and the like).

It is an object of the present invention, which was developed in light of these issues, to provide a lithium secondary batteries having improve durability with respect to high-rate charge and discharge.

The lithium secondary battery provided by the present invention is a lithium secondary battery provided with a nonaqueous electrolyte solution and an electrode body having a positive electrode and a negative electrode. The positive electrode has a structure having a positive electrode active material layer which contains a positive electrode active material, and which is supported on a positive electrode collector. The total pore volume in the positive electrode active material layer is within a range of 0.13 cm³/g to 0.15 cm³/g, and 75% or more of the total pore volume is formed of pores with a diameter of 0.3 μm or less.

The percentage of the total pore volume of the positive electrode active material layer that is formed of pores with a diameter of 0.3 μm or less can be determined by pore distribution measurement using a mercury porosimeter. Pore distribution measurement using a mercury porosimeter can be performed for example using a commercial Shimadzu Autopore IV unit.

Pores with a pore diameter of 0.3 μm or less strongly absorb nonaqueous electrolyte solution by capillary action and the like, providing excellent dispersibility of lithium ions. Thus, if pores with a diameter of 0.3 μm or less constitute 75% or more of the total pore volume, even if some of the nonaqueous electrolyte solution moves outside the positive electrode active material layer due to high-rate charge and discharge, the pores will work to replenish (restore) the distribution of nonaqueous electrolyte solution in the positive electrode active material layer to its original state by capillary action and the like once high-rate charge and discharge is interrupted. That is, nonaqueous electrolyte solution that has moved outside the positive electrode active material layer due to high-rate charge and discharge is reabsorbed inside the positive electrode active material layer, and permeates the positive electrode active material layer uniformly. It is thus possible to eliminate or mitigate deviations (variations) in the distribution of nonaqueous electrolyte solution due to high-rate charge and discharge, and thereby improve durability with respect to high-rate charge-discharge cycles.

If the total pore volume in the positive electrode active material layer is too low (below 0.13 cm³/g), the amount of nonaqueous electrolyte solution permeating the positive electrode active material layer is reduced so that there are not enough lithium ions. If there are not enough lithium ions, the excess voltage during discharge increases, and the high-rate discharge performance of the battery as a whole may be diminished. The distribution of nonaqueous electrolyte solution may also become uneven, producing partial irregularities in the battery reaction, and reducing durability with respect to high-rate charge-discharge cycles in some cases. If the total pore volume is too high (above 0.15 cm³/g), on the other hand, less of the positive electrode active material is present, and there is a risk of diminished energy density and increased initial resistance. High energy densities and durability with respect to high-rate charge-discharge cycles can both be achieved at a high level with a total pore volume in the range of 0.13 cm³/g to 0.15 cm³/g.

In a preferred embodiment of the lithium secondary battery disclosed here, the positive electrode is a positive electrode sheet having a positive electrode active material layer on a positive electrode collector in the form of a long thin sheet, while the negative electrode is a negative electrode sheet having a negative electrode active material layer on a negative electrode collector in the form of a long thin sheet. The electrode body is a coiled electrode body having the positive electrode sheet and negative electrode sheet coiled in the lengthwise direction, with a long thin separator sheet being provided between these two sheets. Application of the present invention is particularly advantageous in this case because a lithium secondary battery provided with such a coiled electrode body is liable to deviations (variations) caused by high-rate charge and discharge in the supported amount of electrolyte solution.

Any of the lithium secondary batteries disclosed here has performance (such as providing high output) suited to a battery to be mounted in a vehicle, and may have particularly good durability with respect to high-rate charge and discharge in particular. Thus, a vehicle equipped with any of the lithium secondary batteries disclosed here is provided by the present invention. In particular, a vehicle (such as an automobile) having this lithium secondary battery as a power source (typically, the power source of a hybrid vehicle or electric vehicle) is provided.

The technology disclosed here can preferably be applied for example to a lithium secondary battery which may be used in a charge-discharge cycle that includes high-rate discharge of 50 A or more (such as 50 A to 250 A) or 100 A or more (such as 100 A to 200 A); or to a lithium secondary battery of the high-capacity type with a theoretical capacity of 1 Ah or more (or 3 Ah or more) which may be used in a charge-discharge cycle that includes high-rate discharge of 10 C or more (such as 10 C to 50 C) or 20 C or more (such as 20 C to 40 C) or the like.

### BRIEF DESCRIPTION OF THE DRAWINGS

FIG. 1 is a side view illustrating a lithium secondary battery of one embodiment of the present invention.

FIG. 2 is a II-II cross-section of FIG. 1.

FIG. 3 illustrates the electrode body of a lithium secondary battery of one embodiment of the present invention.

FIG. 4 is an enlarged cross-section of the main section of a lithium secondary battery of one embodiment of the present invention.

FIG. 5 shows the pore distribution of a lithium secondary battery of one example.

FIG. 6 shows the pore distribution of a lithium secondary battery of one comparative example.

FIG. 7 shows the pore distribution of a lithium secondary battery of one comparative example.

FIG. 8 shows the pore distribution of a lithium secondary battery of one comparative example.

FIG. 9 shows the pore distribution of a lithium secondary battery of one comparative example.

FIG. 10 is a side view illustrating a vehicle equipped with a lithium secondary battery of one embodiment of the present invention.

### BEST MODE FOR CARRYING OUT THE INVENTION

The inventors focused on a phenomenon that occurs in lithium secondary batteries equipped with coiled electrode bodies, whereby internal resistance increases dramatically when high-rate, short-duration (pulsed) discharge and charge is repeated continuously, a situation which is anticipated in lithium secondary batteries for use as vehicular power sources. The effects of such repeated high-rate pulse discharge on the lithium secondary battery were then analyzed in detail.

As a result, it was discovered that when a lithium secondary battery is subjected to repeated high-rate pulse discharge, local deviations (variations) occur in the lithium salt concentration of the nonaqueous electrolyte solution permeating the coiled electrode body, and more specifically that using the battery for high-rate discharge causes part of the nonaqueous electrolyte solution or lithium salt to move to both ends of the coiled electrode body from the center in the axial direction, or to move outside the electrode body from both ends, so that the lithium salt concentration of the axial center of the coiled electrode body is lower than that of the ends (and much lower than the initial lithium salt concentration).

When there are such deviations in the distribution of the nonaqueous electrolyte solution (lithium salt concentration), the amount of lithium ions in the electrolyte solution in the positive electrode is insufficient during high-rate discharge in that part having the relatively low lithium salt concentration, thereby detracting from the high-rate discharge performance of the battery as a whole. Moreover, the battery reaction becomes concentrated in the part with the relatively high lithium salt concentration, contributing to the deterioration of this part. All of these factors can reduce the durability (diminish the performance) of a lithium secondary battery with respect to charge-discharge patterns involving repeated high-rate discharge (high-rate charge-discharge cycles).

Based on these findings, the approach taken by the present invention to improve the durability of a lithium secondary battery with respect to high-rate charge-discharge cycles is to eliminate or reduce deviations in the distribution of the nonaqueous electrolyte solution (lithium salt concentration).

Embodiments of the present invention are explained below with reference to the drawings. In the following drawings, parts and locations that have the same effects are indicated by the same symbols. Dimensional relationships in the drawings (length, width, thickness, etc.) do not reflect actual dimensional relationships. Matters not specifically mentioned in this Description that are necessary for implementing the present invention (such as the configuration and method of manufacturing an electrode body having a positive electrode and negative electrode, the configuration and method of manufacturing the separator and electrolyte, and general techniques for constructing a lithium secondary battery and other batteries and the like) can be understood as design matters by a person skilled in the art based on prior art in the field.

Although this is not intended as a limitation, the present invention is explained in detail below using the example of a lithium secondary battery (lithium-ion battery) comprising a coiled electrode body and a nonaqueous electrolyte contained in a cylindrical container.

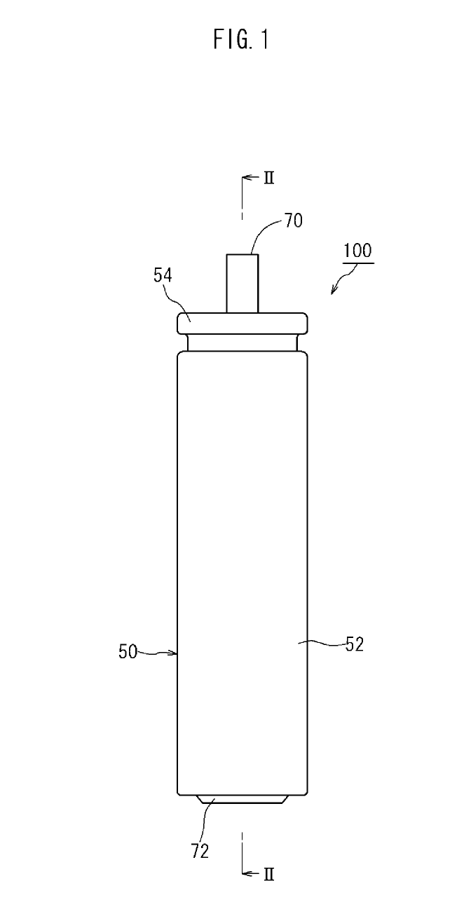

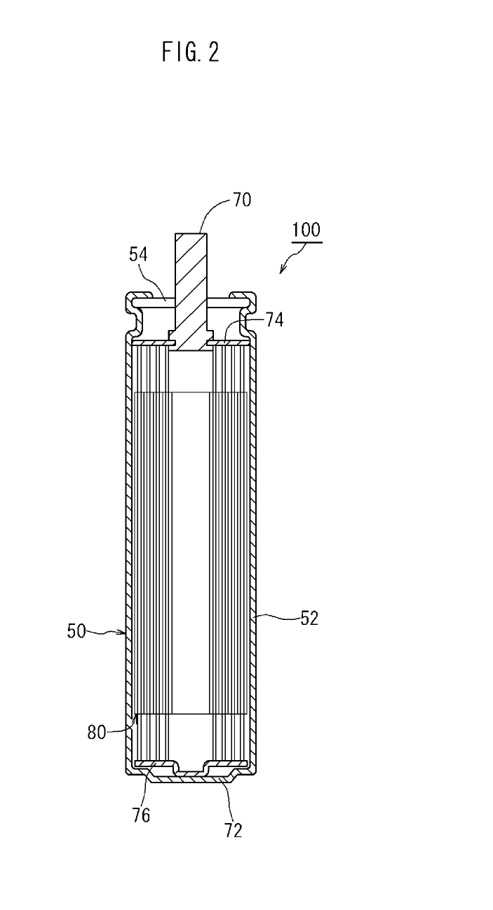

FIGS. 1 to 3 show the general configuration of a lithium-ion battery of one embodiment of the present invention. This lithium-ion battery 100 is configured with electrode body (coiled electrode body) 80 comprising long thin positive electrode sheet 10 and long thin negative electrode sheet 20 coiled with long thin separator 40 between the two, contained together with a nonaqueous electrolyte solution (not shown) in container 50 having a shape (cylindrical shape) capable of containing this coiled electrode body 80.

Container 50 comprises container body 52 in the shape of a cylinder closed at the bottom and open at the top, and cap 54, which closes the opening. A metal material such as aluminum, steel, nickel-plated SUS or the like (nickel-plated SUS in this embodiment) is preferred as the material of container 50. Alternatively, container 50 may be molded of a resin material such as PPS, polyimide resin or the like. Positive terminal 70, which is connected electrically to positive electrode 10 of coiled electrode body 80, is provided on the upper surface of container 50 (that is, cap 54). Negative terminal 72 (doubling as container body 52 in this embodiment), which is connected electrically to negative electrode 20 of coiled electrode body 80, is provided on the lower surface of container 50. Coiled electrode body 80 is contained together with a nonaqueous electrolyte solution (not shown) in container 50.

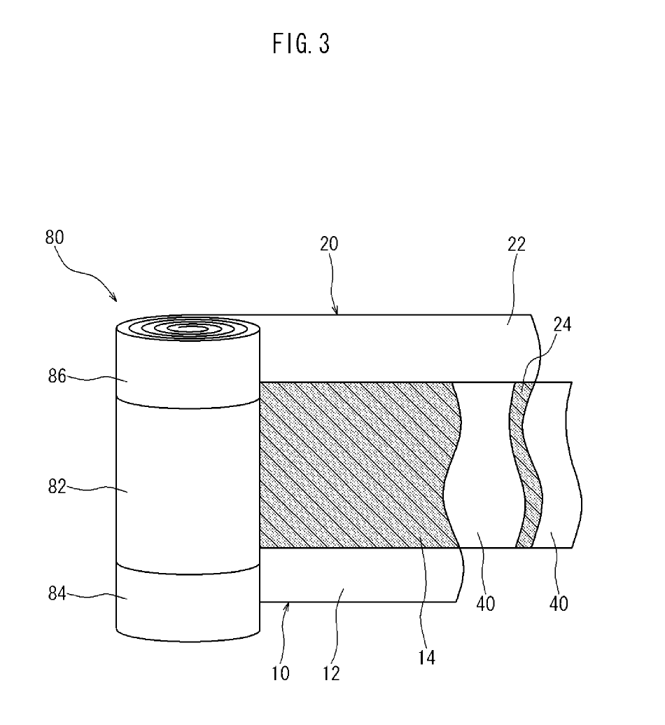

Coiled electrode body 80 of this embodiment is similar to the coiled electrode body of an ordinary lithium-ion battery apart from the configuration of the layer containing the active material (positive electrode active material layer) on positive electrode sheet 10, and as shown in FIG. 3, it has a long thin (band-shaped) sheet structure before assembly of coiled electrode body 80.

The structure of positive electrode sheet 10 comprises positive electrode active material layer 14 containing the positive electrode active material supported on both sides of positive collector 12, which is in the form of a long thin sheet of foil. However, no positive electrode active material layer 14 adheres along the edge of positive electrode sheet 10 at one extremity in the direction of width (lower edge in drawing), thereby forming a part without a formed positive electrode active material layer, in which a specific width of positive electrode collector 12 is exposed.

Like positive electrode sheet 10, negative electrode sheet 20 has a structure comprising negative electrode active material layer 24 containing the negative active material supported on both sides of negative collector 22, which is in the form of a long thin sheet of foil. However, no negative electrode active material layer 24 adheres along the edge of negative electrode sheet 20 at one extremity in the direction of width (upper edge in drawing), thereby forming a part without a formed negative electrode active material layer, in which a specific width of negative electrode collector 22 is exposed.

When preparing coiled electrode body 80, positive electrode sheet 10 and negative electrode sheet 20 are superimposed with separator 40 in between. Positive electrode sheet 10 and negative electrode sheet 20 are slightly offset in the direction of width so that the part without formed positive electrode active material layer on positive electrode sheet 10 and the part without formed negative electrode active material layer on negative electrode sheet 20 protrude on either side of separator sheet 40 in the direction of width. Coiled electrode body 80 can then be prepared by coiling the layered body obtained in this way.

Coiled core part 82 (the part in which positive electrode active material layer 14 of positive electrode sheet 10, negative electrode active material layer 24 of negative electrode sheet 20 and separator 40 are tightly layered together) is formed in the center of coiled electrode body 80 in the coiling axis direction. The parts of positive electrode sheet 10 and negative electrode sheet 20 without formed electrode mix layers protrude outside coiled core part 82 at either end of coiled electrode body 80 in the coiling axis direction. Positive lead terminal 74 and negative lead terminal 76 are attached, respectively, to positive protruding part 84 (part without formed positive electrode active material layer 14) and negative protruding part 86 (part without formed negative electrode active material layer 24), which are thereby electrically connected, respectively, to positive terminal 70 and negative terminal 72 (which doubles here as container body 52).

Apart from positive electrode sheet 10, the constituent elements of this coiled electrode boy 80 may be similar to those of the coiled electrode body of a conventional lithium-ion battery, without any particular limitations. For example, negative electrode sheet 20 may be formed by applying negative electrode active material layer 24 consisting primarily of a lithium-ion battery negative active material to long thin negative electrode collector 22. Aluminum foil or another metal foil suited to positive electrodes can be used favorably for thin negative electrode collector 22. One or two or more substances conventionally used in lithium-ion batteries may be used for the negative active material, without any particular limitations. Desirable examples include graphite carbon, amorphous carbon and other carbon materials, and lithium-containing transition metal oxides, transition metal nitrides and the like.

Positive electrode sheet 10 can be formed by applying positive electrode active material layer 14 consisting primarily of a lithium-ion battery positive electrode active material to long thin positive electrode collector 12. Aluminum foil or another metal foil suited to positive electrodes can be used favorably for positive electrode collector 12.

One or two or more substances conventionally used in lithium-ion batteries can be used for the positive electrode active material, without any particular limitations. The technology disclosed here can be used favorably with a positive electrode active material consisting primarily of an oxide containing lithium and a transition metal element as constituent metal elements (lithium-transition metal oxide), such as lithium nickel oxide (LiNiO₂), lithium cobalt oxide (LiCoO₂), lithium manganese oxide (LiMn₂O₄) or the like. Of these, it is preferably used with a positive electrode active material consisting primarily of a lithium-nickel-cobalt-manganese composite oxide such as LiNi_{1/3}Co_{1/3}Mn_{1/3}O₂ (typically, a positive electrode active material consisting virtually of a lithium-nickel-cobalt-manganese composite oxide).

A lithium-nickel-cobalt-manganese composite oxide here may either an oxide in which the constituent metal elements are Li, Ni, Co and Mn, or an oxide containing at least one metal element other than Li, Ni, Co and Mn (that is, a transition metal element and/or typical metal element other than Li, Ni, Co and Mn). This metal element may for example be one or two or more elements selected from the group consisting of Al, Cr, Fe, V, Mg, Ti, Zr, Nb, Mo, W, Cu, Zn, Ga, In, Sn, La and Ce. The same applies in the case of lithium-nickel oxides, lithium-cobalt oxides and lithium-manganese oxides.

A lithium-transition metal oxide powder prepared by well-known conventional methods can be used for example as such a (typically particulate) lithium-transition metal oxide. For example, a lithium-transition metal oxide powder consisting virtually of secondary particles with an average particle diameter in the range of about 1 μm to 25 μm can be used by preference as the positive electrode active material.

Positive electrode active material layer 14 can contain, as necessary, one or two materials that can be used as constituent elements in the positive electrode active material layer of an ordinary lithium-ion battery. Examples of such materials include conductive materials. Carbon powder, carbon fiber and other carbon materials can preferably be used as such conductive materials. A nickel powder or other conductive metal powder or the like can also be used. Other examples of materials that can be used as components in the positive electrode active material layer include various polymer materials capable of functioning as binders for the constituent materials.

The amount of the positive electrode active material as a percentage of the positive electrode active material layer as a whole is not particularly limited but is preferably about 50 mass % or more (typically 50 mass % to 95 mass %), or more preferably about 75 mass % to 90 mass %. When the composition of the positive electrode active material layer includes a conductive material, the amount of the conductive material as a percentage of the positive electrode active material layer can be 3 mass % to 25 mass %, or preferably about 3 mass % to 15 mass %. When positive electrode active material layer-forming components (such as polymer materials) other than the positive electrode active material and conductive material are included, the total content of these optional components is preferably about 7 mass % or less, or more preferably about 5 mass % or less (such as about 1 mass % to 5 mass %).

A method of dispersing the (typically particulate) positive electrode active material and other positive electrode active material layer-forming components in a suitable solvent (preferably an aqueous solvent) to obtain a positive electrode active material layer-forming paste that is then applied in a band on one or both sides (both sides in this case) of positive electrode collector 12 and dried can preferably be adopted as the method of forming positive electrode active material layer 14. After drying of the positive electrode active material layer-forming paste, the thickness and density of positive electrode active material layer 14 can be adjusted by means of a suitable pressing method (such as roll pressing, flat plate pressing or another well-known conventional pressing method).

An example of a suitable separator 40 for use between positive and negative electrode sheets 10 and 20 is one composed of porous polyolefin resin. For example, a porous separator sheet of synthetic resin (such as polyethylene or other polyolefin resin) with a length of 2 m to 4 m (such as 3.1 m), a width of 8 cm to 12 cm (such as 11 cm) and a thickness of 5 μm to 30 μm (such as 25 μm) can be used favorably. When a solid electrolyte or gel electrolyte is used as the electrolyte, a separator may be unnecessary (that is, the electrolyte itself may function as a separator).

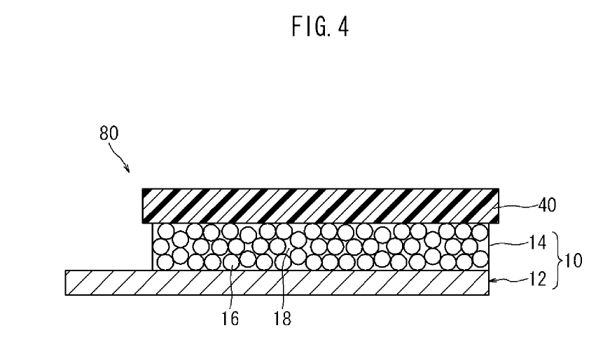

Next, FIG. 4 is further used to explain positive electrode sheet 10 of this embodiment. FIG. 4 is an enlarged model cross-section of a part of coiled electrode body 80 of this embodiment cut along the coiling axis to show positive collector 12 with positive electrode active material layer 14 formed along one surface of the collector and separator 40 facing positive electrode active material layer 14.

As shown in FIG. 4, positive electrode active material layer 14 has positive electrode active material particles 16 composed virtually of secondary particles, and these positive electrode active material particles 16 are fixed to each other with a binder (not shown). Positive electrode active material layer 14 also has spaces (pores) 18 whereby the nonaqueous electrolyte solution permeates positive electrode active material layer 14, and these spaces (pores) 18 can be formed by gaps or the like between the fixed positive electrode active material particles 16.

In this embodiment, the total pore volume within positive electrode active material layer 14 is in the range of 0.13 cm³/g to 0.15 cm³/g.

If the total pore volume within positive electrode active material layer 14 is too low (below 0.13 cm³/g), the amount of nonaqueous electrolyte solution permeating positive electrode active material layer 14 is reduced, so that the amount of lithium ions is insufficient. If the amount of lithium ions is insufficient, the excess voltage during discharge increases, and the high-rate discharge performance of the battery as a whole may be diminished. The distribution of nonaqueous electrolyte solution may also become uneven, producing partial irregularities in the battery reaction, and reducing durability with respect to charge-discharge cycles in some cases. If the total pore volume is too high (above 0.15 cm³/g), on the other hand, the packed amount of positive electrode active material is reduced, and there is a risk of diminished energy density and increased initial resistance. Therefore, the total pore volume is preferably within the range of 0.13 cm³/g to 0.15 cm³/g for purposes of achieving high energy densities and ensuring durability with respect to charge-discharge cycles.

In the present embodiment, 75% or more of the total pore volume within the positive electrode active material layer 14 consists of pores with a pore diameter of 0.3 μm or less.

Small pores with a pore diameter of 0.3 μm or less have a strong ability to absorb nonaqueous electrolyte solution by capillary action or the like, and provide excellent permeability of the nonaqueous electrolyte solution. Therefore, making the percentage of pores with a diameter of 0.3 μm or less be 75% or more of the total pore volume is a strategy aimed at replenishing (restoring) the distribution of nonaqueous electrolyte solution within positive electrode active material layer 14 to its initial state by capillary action or the like once high-rate charge and discharge is interrupted if some of the nonaqueous electrolyte solution or lithium salt has moved from the axial center of coiled electrode body 80 to both ends or from both ends outside electrode body 80 due to use in high-rate pulse discharge, so that the lithium salt concentration at the axial center of coiled electrode body 80 is lower than the concentration at both ends. That is, nonaqueous electrolyte solution that has moved to the ends of or outside electrode body 80 due to high-rate charge and discharge is reabsorbed into the axial center of electrode body 80 so as to uniformly peremeate electrode body 80 (especially positive electrode active material layer 14). Deviations (variations) in the distribution of the nonaqueous electrolyte solution due to high-rate charge and discharge can thus be eliminated or reduced, and durability improved with respect to high-rate charge-discharge cycles.

The total pore volume of positive electrode active material layer 14 can be adjusted for example by changing the density of positive electrode active material layer 14. The size of the pore volume can generally be understood to be in inverse relation with the size of the density of positive electrode active material layer 14. That is, the greater the relative total pore volume, the lower the relative density. Thus, the total pore volume of positive electrode active material layer 14 can be adjusted by changing the density of positive electrode active material layer 14. Specifically, the thickness and density of positive electrode active material layer 14 are adjusted by suitable pressing (compression) treatment performed after the positive electrode active material layer-forming paste has been coated on positive electrode collector 12 and dried. The total pore volume of positive electrode active material layer 14 can be adjusted to the favorable range disclosed here by varying the pressing pressure at this time. Other methods for adjusting the total pore volume to the suitable range include changing the amount of the conductive material and/or binder and the like.

The pore distribution (pore size, etc.) within positive layer 14 can be adjusted for example by varying the particle size (average particle diameter and particle size distribution (wide or narrow)) of positive electrode active material particles 16. Since the packing efficiency generally decreases as the particle size increases, the percentage of pores with a large pore diameter also tends to rise. Thus, the pore distribution of positive electrode active material layer 14 can be adjusted to the appropriate range disclosed here by changing the particle size of positive electrode active material particle 16 (average particle diameter and particle size distribution). In addition, one method that can be adopted for adjusting the percentage of pores 0.3 μm or less in diameter to the appropriate range is to change the amount of conductive material and/or binder or the like.

Moreover, the technology disclosed here also provides a method for manufacturing a lithium secondary battery having a positive electrode comprising a positive electrode collector whereon is provided a positive electrode active material layer prepared with a total pore volume in the range of 0.13 cm³/g to 0.15 cm³/g wherein pores 0.3 μm or less in diameter constitute 75% or more of the pore volume.

This manufacturing method encompasses forming, on a positive electrode collector, a positive electrode active material layer wherein the total pore volume has been adjusted to 0.13 cm³/g to 0.15 cm³/g, and the percentage of pores with a diameter of 0.3 μm or less has been adjusted to 75% or more of the pore volume; and

constructing a lithium secondary battery using a positive electrode equipped with this positive electrode active material layer on a positive electrode collector.

A positive electrode active material layer wherein the total pore volume has been adjusted to 0.13 cm³/g to 0.15 cm³/g, and the percentage of pores with a diameter of 0.3 μm or less has been adjusted to 75% or more of the pore volume is obtained by setting the particle size (average particle diameter and particle size distribution) of the positive electrode active material particles contained in the positive electrode active material layer and/or the conditions for forming the positive electrode active material layer on the positive electrode collector (for example, the pressing conditions when adjusting the thickness of the positive electrode active material layer and other formation conditions) so as to achieve the suitable ranges described above, and forming the positive electrode active material layer in accordance with the set conditions.

Therefore, the matter disclosed here includes a method for manufacturing a positive electrode comprising, on a positive electrode collector, a positive electrode active material layer wherein the total pore volume has been adjusted to 0.13 cm³/g to 0.15 cm³/g and the percentage of pores with a diameter of 0.3 μm or less has been adjusted to 75% or more of the pore volume, wherein the method encompasses setting the particle size (average particle diameter and particle size distribution) of the positive electrode active material particles contained in the positive electrode active material layer and/or the conditions for forming the positive electrode active material layer on the positive electrode collector (for example, the pressing conditions when adjusting the thickness of the positive electrode active material layer and other formation conditions) so as to achieve the suitable ranges described above, and forming the positive electrode active material layer on the positive electrode collector in accordance with the set conditions. A positive electrode manufactured by this method can be used favorably as a lithium secondary battery positive electrode.

A coiled electrode boy 80 of this configuration is contained in container body 52, and a suitable nonaqueous electrolyte solution is disposed (injected) inside container body 52. The nonaqueous electrolyte solution contained in container body 52 together with coiled electrode body 80 can be similar to a nonaqueous electrolyte solution used in a conventional lithium-ion battery, without any particular limitations. This nonaqueous electrolyte solution typically has a composition comprising a supporting salt in a suitable nonaqueous solvent. Examples of the nonaqueous solvent include ethylene carbonate (EC), ethylmethyl carbonate (EMC), dimethyl carbonate (DMC), diethyl carbonate (DEC) and propylene carbonate (PC). LiPF₆, LiBF₄, LiAsF₆, LiCF₃SO₃, LiClO₄ and other lithium salts can be used by preference as the supporting salt. For example, a nonaqueous electrolyte solution comprising LiPF₆ contained at a concentration of about 1 mol/liter as a supporting salt in a mixed solvent containing EC, EMC and DMC at a volume ratio of 3:4:3 can be used by preference.

This nonaqueous electrolyte solution is contained together with coiled electrode body 80 in container body 52, and the opening of container body 52 is sealed with cap 54 to complete construction (assembly) of lithium-ion battery 100 of this embodiment. The process of sealing container body 52 and the process of disposing (injecting) the electrolyte solution can be performed in the same way as processes performed in the manufacture of conventional lithium-ion batteries. The battery is then subjected to suitable conditioning (initial charge-discharge). Other steps such as degassing, quality checking and the like can be performed as necessary.

### EXAMPLES

The present invention is explained in more detail below based on examples.

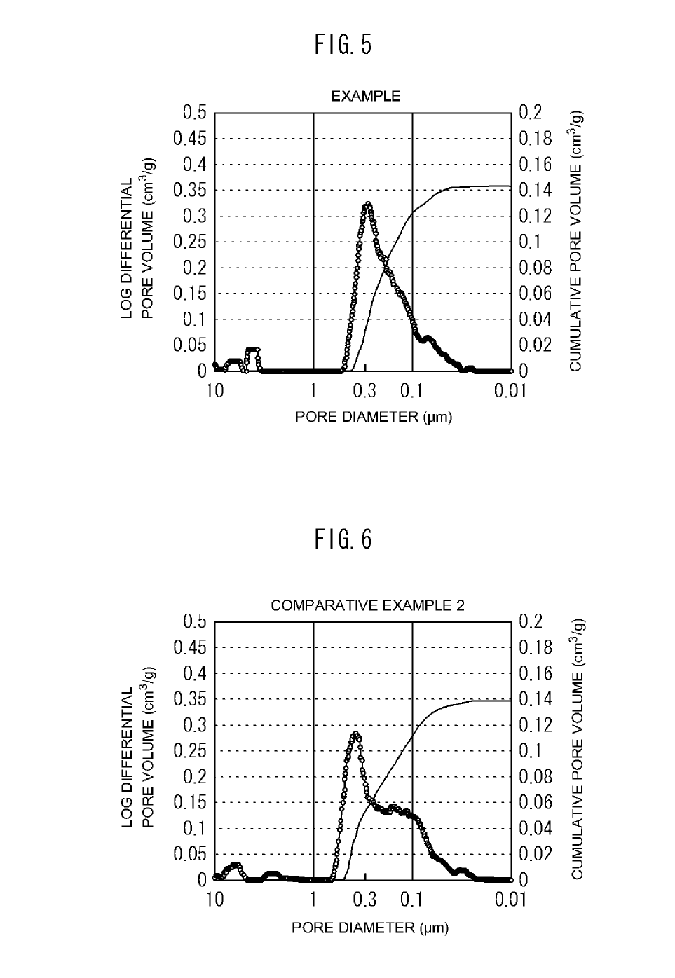

Lithium-nickel-cobalt-manganate (LiNi_{1/3}Co_{1/3}Mn_{1/3}O₂) powder with an average particle diameter of 6 μm was used as the positive electrode active material. First, the positive electrode active material power, acetylene black (conductive material) and vinylidene polyfluoride (PVdF) were mixed in N-methyl pyrrolidone (NMP) to a solids concentration of about 50 mass % and a mass ratio of 87:10:3 of the three materials to prepare a positive electrode active material layer paste. Bands of this positive electrode active material layer paste were coated on either side of a long thin sheet of aluminum foil (positive electrode collector 12), and dried to prepare positive electrode sheet 10 comprising positive electrode active material layer 14 on both sides of positive electrode collector 12. The coated amount of the positive electrode active material layer paste was adjusted to about 20 mg/cm² (as solids) on both sides. After drying, positive electrode active material layer 14 was pressed to a density of about 2.45 g/cm³. When the pore distribution of positive electrode active material layer 14 after pressing was measured with a mercury porosimeter, the total pore volume (cumulative pore volume) of positive electrode active material layer 14 was 0.144 cm³/g, and the percentage of pores with a pore diameter of 0.3 μm or less in the total pore volume was 78%. The pore distribution of the positive electrode active material layer of the example is shown in FIG. 5.

Three different positive electrode sheets with different pore distributions of the positive electrode active material layer (percentage of pores with a diameter of 0.3 μm or less) were also prepared as Comparative Examples 1 to 3. Specifically, positive electrode sheets were prepared with the percentage of pores with a diameter of 0.3 μm or less reduced to 71%, 60% and 45% in order from Comparative Example 1 to 3. The pore distribution of the positive electrode sheet of Comparative Example 2 is shown in FIG. 6. The pore distribution of the positive electrode active material layer was adjusted by changing the particle size (average particle diameter) of the positive electrode active material powder used. The positive electrode sheets were prepared as in the example apart from the change in the particle size (average particle diameter) of the positive electrode active material powder.

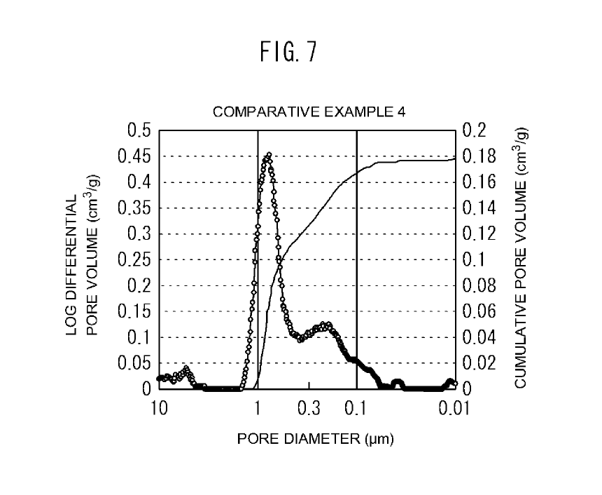

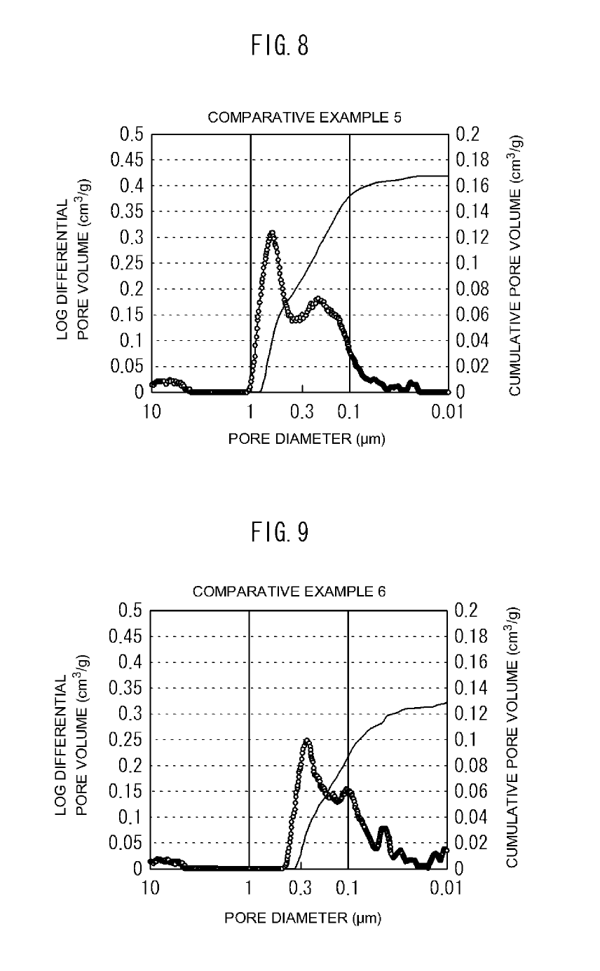

Three different positive electrode sheets with differing total pore volumes (cumulative pore volumes) of the positive electrode active material layer were also prepared as Comparative Examples 4 to 6. Specifically, positive electrode sheets were prepared with the total pore volume changed to 0.177 cm³/g, 0.167 cm³/g and 0.125 cm³/g in order from Comparative Example 4 to 6. The pore distributions of the positive electrode sheets of Comparative Examples 4 to 6 are shown in FIGS. 7 to 9. The total pore volume of the positive electrode active material layer was adjusted by changing the density (pressing pressure) of the positive electrode active material layer and the particle size (average particle diameter) of the positive electrode active material powder used. The positive electrode sheets were prepared as in the example apart from the changes in the density of the positive electrode active material layer (pressing pressure) and the particle size (average particle diameter) of the positive electrode active material powder.

Next, lithium-ion batteries for testing purposes were prepared using the positive electrode sheets of the example and Comparative Examples 1 to 6 above. The lithium-ion batteries for testing purposes were prepared as follows.

Graphite powder with an average particle diameter of about 10 μm was used as the negative active material. First, graphite powder, styrene-butadiene rubber (SBR), polytetrafluoroethylene (PTFE) and CMC were dispersed in water at a mass ratio of 97:1:1:1 of the 4 materials to prepare a negative electrode active material layer paste. This negative electrode active material layer paste was coated on both sides of a long thin sheet of copper foil (negative collector 22) to prepare negative electrode sheet 20 comprising negative electrode active material layer 24 on both sides of negative electrode collector 22.

Positive electrode sheet 10 and negative electrode sheet 20 were then coiled with two separator sheets (porous polypropylene) 40 in between to prepare coiled electrode body 80. The resulting coiled electrode body 80 was contained together with a nonaqueous electrolyte solution in battery container 50, and the opening of battery container 50 was sealed air-tightly. The nonaqueous electrolyte solution was a solution containing about 1 mol/liter of LiPF₆ as the supporting salt in a mixed solvent comprising ethylene carbonate (EC), ethylmethyl carbonate (EMC) and dimethyl carbonate (DMC) at a volume ratio of 3:4:3. Lithium-ion battery 100 was assembled in this way. Next, initial charge-discharge treatment (conditioning) was performed by ordinary methods to obtain a lithium-ion battery for testing purposes. The rated capacity of this lithium-ion battery was 180 mAh.

Each of the lithium-ion batteries for testing purposes obtained in this way was subjected to a charge-discharge cycle test using a charge-discharge pattern of repeated constant-current (CC) discharge for 10 seconds at 3.6 A (corresponding to a discharge hour rate of 20 C). Specifically, the battery was CC discharged for 10 seconds at 20 C in a room temperature (about 25° C.) environment, and then CC charged for 100 seconds at 2 C, and this charge-discharge cycle was repeated 4000 times continuously.

The resistance increase rate was also calculated from the IV resistance before the charge-discharge cycle test (initial resistance of lithium-ion battery) and the IV resistance after the charge-discharge cycle test. The IV resistance before and after the charge-discharge cycles was calculated from the voltage drop after 10 seconds of discharge during pulse discharge at −15° C., 20 C in each case. The IV resistance increase rate was derived from “IV resistance after charge-discharge cycle test/IV resistance before charge-discharge cycle test”. The results are shown in Table 1.

TABLE 1

| | | | | | Resistance |
|---|---|---|---|---|---|
| | Mix | Cumulative | Initial | % of di. | increase rate after |
| | density | pore volume | resistance | ≦0.3 μm | high-rate charge- |
| Test | (g/cm³) | (cm³/g) | (mΩ) | pores | discharge cycles |
| Ex. | 2.45 | 0.144 | 178 | 78 | 1.06 |
| CE 1 | 2.45 | 0.141 | 180 | 71 | 1.3 |
| CE 2 | 2.45 | 0.138 | 183 | 60 | 1.34 |
| CE 3 | 2.45 | 0.14 | 190 | 45 | 1.68 |
| CE 4 | 2.3 | 0.177 | 213 | 40 | 1.26 |
| CE 5 | 2.3 | 0.167 | 205 | 45 | 1.1 |
| CE 6 | 2.6 | 0.125 | 180 | 85 | 1.78 |

As shown in Table 1, the battery of the example had low initial resistance in comparison with the batteries of Comparative Examples 1 to 6. It exhibited almost no rise in IV resistance even after 4000 repeated cycles of high-rate charge and discharge, with an extremely low resistance increase rate of 1.06.

By contrast, the batteries of Comparative Examples 1 to 3 in which the percentage of pores of diameter 0.3 μm or less was less than 75% exhibited roughly the same initial resistance as in the example, but the IV resistance rose much more than in the example after 4000 repeated cycles of high-rate charge and discharge. The fact that this occurred even though the batteries of Comparative Examples 1 to 3 have roughly the same total pore volume as the example suggests a strong relationship between durability with respect to high-rate charge-discharge cycles and the percentage of pores with a diameter of 0.3 μm or less. That is, because pores with a diameter of 0.3 μm or less have excellent ability to absorb nonaqueous electrolyte solution and disperse lithium ions, it appears that deviations (irregularities) in the distribution of nonaqueous electrolyte solution due to high-rate charge and discharge can be eliminated or reduced by increasing the percentage of such pores, thereby improving durability with respect to high-rate charge-discharge cycles.

In the batteries of Comparative Examples 4 and 5, which had a total pore volume in excess of 0.15 cm³/g, it was possible to control the increase in IV resistance to a certain extent even after 4000 cycles of repeated charge and discharge, and durability was also excellent. However, the initial resistance exceeded 200 mΩ, which was much higher than in the example. It appears that if the total pore volume is too great, the conductivity of the positive electrode active material layer is lower because the density of the positive electrode active material layer is reduced proportionally. Thus, the total pore volume is preferably less than 0.15 cm³/g from the standpoint of obtaining good battery input-output characteristics.

On the other hand, in the battery of Comparative Example 6, which had a total pore volume of less than 0.13 cm³/g, the density of the positive electrode active material layer was high and the effect of excellent initial resistance was obtained, but the IV resistance rose considerably after 4000 cycles of repeated high-rate charge and discharge. It appears that if the total pore volume is too small, the distribution of nonaqueous electrolyte solution becomes uneven and durability is reduced because the amount of nonaqueous electrolyte solution permeating the positive electrode active material layer is insufficient. That is, the total pore volume is preferably more than 0.13 cm³/g for purposes of obtaining good cycle durability.

Preferred embodiments of the present invention were explained above, but these descriptions are not limiting, and various modifications are of course possible.

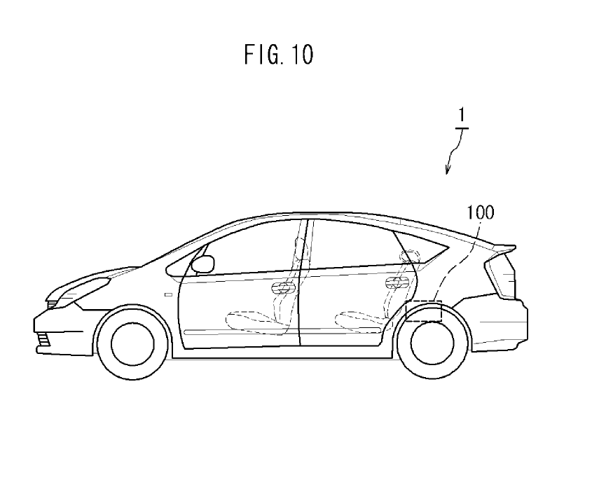

Any of the lithium secondary batteries 100 disclosed here has the properties (ability to provide high output for example) necessary for a vehicle-mounted battery, and in particular may have excellent durability with respect to high-rate charge and discharge. Therefore, the present invention provides vehicle 1 equipped with any of the lithium secondary batteries 100 disclosed here as shown in FIG. 10. In particular, it provides vehicle 1 (an automobile for example) having this lithium secondary battery 100 as a power source (typically, the power source of a hybrid vehicle or electric vehicle).

The technology disclosed here can preferably be applied for example to lithium secondary battery 100 which may be used in a charge-discharge cycle that includes high-rate discharge of 50 A or more (such as 50 A to 250 A) or 100 A or more (such as 100 A to 200 A); or to a lithium secondary battery of the high-capacity type with a theoretical capacity of 1 Ah or more (or 3 Ah or more) which may be used in a charge-discharge cycle that includes high-rate discharge of 10 C or more (such as 10 C to 50 C) or 20 C or more (such as 20 C to 40 C) or the like.

### INDUSTRIAL APPLICABILITY

A lithium secondary battery with enhanced durability with respect to high-rate charge and discharge can be provided by the configuration of the present invention.

1. A lithium secondary battery provided with a nonaqueous electrolyte solution and an electrode body having a positive electrode and a negative electrode, wherein
the positive electrode has a structure having a positive electrode active material layer which contains a positive electrode active material, and which is supported on a positive electrode collector, and wherein
the positive electrode active material layer is pressed to implement adjustment such that the layer exhibits a mixture density that allows the total pore volume within the positive electrode active material layer is to be in a range of 0.13 cm³/g to 0.15 cm³/g, and 75% or more of the total pore volume to be formed of pores with a diameter of 0.3 μm or less.

2. The lithium secondary battery according to claim 1, wherein
the positive electrode is a positive electrode sheet having a positive electrode active material layer on a positive electrode collector in the form of a long thin sheet, the negative electrode is a negative electrode sheet having a negative electrode active material layer on a negative electrode collector in the form of a long thin sheet, and
the electrode body is a coiled electrode body having the positive electrode sheet and negative electrode sheet coiled in the lengthwise direction, with a long thin separator sheet being provided between these two sheets.

3. A lithium secondary battery according to claim 1, wherein the positive electrode active material is a lithium-nickel-cobalt-manganese composite oxide.

4. A vehicle equipped with a lithium secondary battery according to claim 1.
